(19) United States
(12) Patent Application Publication
(10) Pub. No.: US 2025/0045819 A1
(43) Pub. Date: Feb. 6, 2025

(54) BUDGET RECOVERY AND REPAIR FROM DIVERGENCE

(71) Applicant: Wells Fargo Bank, N.A., San Francisco, CA (US)

(72) Inventors: Himanshu Baral, Union City, CA (US); Anthony Scott Best, Huntersville, NC (US); Daniel Jerome Clifford, Minneapolis, MN (US); Cathy Ann Costa, Walnut Creek, CA (US); Frank A. DiGangi, Statesville, NC (US); Marta Alejandra Gonzalez, Bethesda, MD (US); Venkatesh Hebbar, Chester Springs, PA (US); Matthew J. Heffron, Bishop, GA (US); Brenda S. Makowski, Elmhurst, IL (US); Dale C. Miller, Clemmons, NC (US); Alyssa R. Santiago, Sioux Falls, SD (US); Michael J. Sbandi, Harrisburg, NC (US)

(21) Appl. No.: 18/050,637

(22) Filed: Oct. 28, 2022

(51) Int. Cl. G06Q 40/02; G06T 11/20

(52) U.S. Cl. CPC G06Q 40/02; G06T 11/206

(57) ABSTRACT

A method may include accessing a financial account of a user to detect an expenditure. The method may include determining a category of the expenditure. The method may include determining whether the user has a financial goal pertaining to the category. The method may include generating a user interface, the user interface including a non-textual visualization pertaining to the financial goal. The method may include presenting the user interface on a computing device of the user.

### BACKGROUND

Individuals often rely on computer-based systems to manage their personal finances. Conventional personal financial management systems include software and internet-based systems. Certain systems allow users to create budgets and goals, and to categorize transactions into various categories. However, many systems can seem impersonal and are easy for an individual to ignore due to the lack of personal and emotional impact generated by many budgeting systems. Therefore, users may not feel motivated to stick to their budgeting goals.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is an illustration of components of a client device and an application server, according to various examples.

FIG. 2 illustrates a first user interface for providing an expenditure visualization, according to various examples.

FIG. 3 illustrates a second example user interface for providing an expenditure visualization, according to various examples.

FIG. 4 illustrates a chart for representing available expenditure over time, according to various examples.

FIG. 5 illustrates an example machine learning module for a decentralized asset dispositioning tool, according to various embodiments.

FIG. 6 is a flowchart diagram identifying operations of a method of generating a user interface, according to various examples.

FIG. 7 is a block diagram illustrating an example machine upon which any one or more of the techniques (e.g., methodologies) discussed herein may be performed, according to an example embodiment.

### DETAILED DESCRIPTION

As indicated in the Background, users often turn to computer-based systems to manage personal finances. Some personal finance systems include budgeting programs. However, budgeting programs available today typically include bar charts and other impersonal visualizations that do not have an emotional or personal impact on the user. As such, a user may not feel motivated to stick to a budget, causing users to fail to meet financial goals.

As described herein in more detail, financial and budgeting systems may be improved in a number of manners. First, systems described herein provide visualizations in a user interface to help users visualize their goals. The visualizations can be selected based on the impact that the visualizations are likely to have on a user. This visualization can tether the expenditure to something tangible or emotional to the user, thus helping to improve or increase the likelihood that the user will stick to a personal budget.

A second described improvement can provide users with suggested actions to take just before or after spending money. The system described herein can provide suggested actions to take after spending money (or before, as a suggestion or prediction) to put a user back on track on the user's budget, including how to recover a user budget subsequent to making an expenditure.

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., RAM, cache, hard drive) accessible by the component via an API or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include transmitting data (e.g., a hypertext markup language file) from a first device (such as a web server) to the computing device for rendering on a display device of the computing device via a rendering engine such as a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all of the portions/elements are displayed simultaneously. Unless indicated as such, the use of “presenting a user interface” does not infer either one of these options.

Additionally, the elements and portions are sometimes described as being configured for a certain purpose. For example, an input element may be described as being configured to receive an input string. In this context, “configured to” may mean presentation of a user interface element that is capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database.

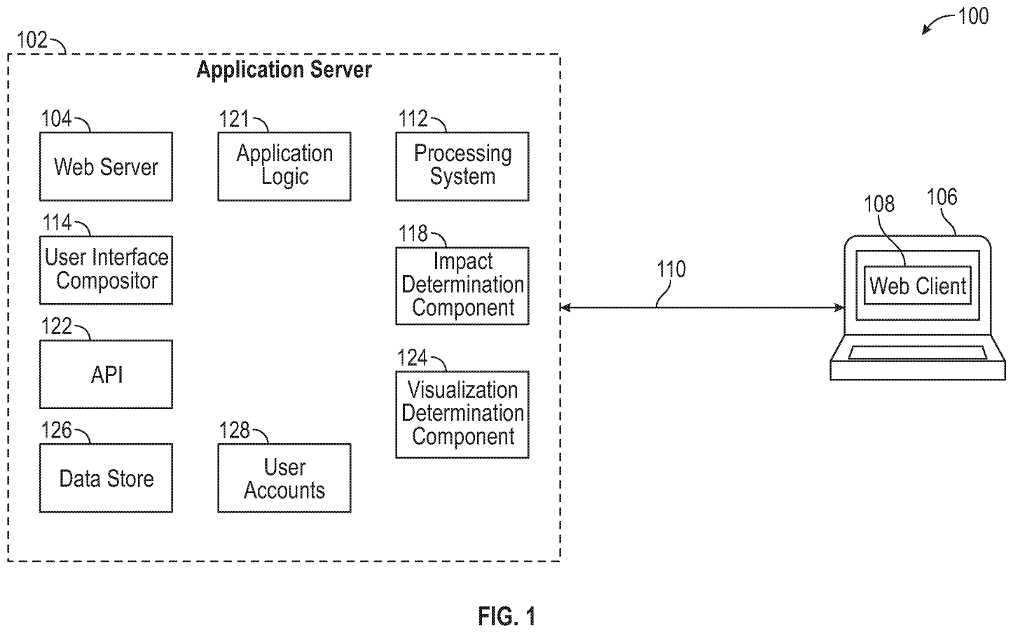

FIG. 1 is an illustration 100 of components of a client device and an application server, according to various examples. FIG. 1 shows an application server 102, a web server 104, a client device 106, a web client 108, data 110, a processing system 112, a user interface compositor 114, an impact determination component 118, an application logic 121, an API 122, a visualization determination component 124, a data store 126, and a user accounts 128.

Application server 102 is illustrated as set of separate elements (e.g., component, logic, etc.). However, the functionality of multiple, individual elements may be performed by a single element. An element may represent computer program code that is executable by processing system 112. The program code may be stored on a storage device (e.g., data store 126) and loaded into a memory of the processing system 112 for execution. Portions of the program code may be executed in a parallel across multiple processing units (e.g., a core of a general-purpose computer processor, a graphical processing unit, an application specific integrated circuit, etc.) of processing system 112. Execution of the code may be performed on a single device or distributed across multiple devices. In some examples, the program code may be executed on a cloud platform (e.g., MICROSOFT AZURE® and AMAZON EC2®) using shared computing infrastructure.

Client device 106 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Client device 106 and application server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks or peer-to-peer (e.g., Bluetooth®, Wi-Fi Direct), or other combinations or permutations of network protocols and network types. The network may include a Local Area Network (LAN) or Wide-Area Network (WAN), or combinations of LAN's or WAN's, such as the Internet. Client device 106 and application server 102 may communicate data 110 over the network. Data 110 may include a web application, user inputs, etc., as discussed herein.

In some examples, the communication may occur using an application programming interface (API) such as API 122. An API provides a method for computing processes to exchange data. A web-based API (e.g., API 122) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a Database (e.g., data store 126).

APIs may also be defined in frameworks provided by an operating system (OS) to access data in an application that an application may not regularly be permitted to access. For example, the OS may define an API call to obtain the current location of a mobile device the OS is installed on. In another example, an application provider may use an API call to request a be authenticated using a biometric sensor on the mobile device. By segregating any underlying biometric data—e.g., by using a secure element—the risk of unauthorized transmission of the biometric data may be lowered.

Application server 102 may include web server 104 to enable data exchanges with client device 106 via web client 108. Although generally discussed in the context of delivering webpages via the Hypertext Transfer Protocol (HTTP), other network protocols may be utilized by web server 104 (e.g., File Transfer Protocol, Telnet, Secure Shell, etc.). A user may enter in a uniform resource identifier (URI) into web client 108 (e.g., the INTERNET EXPLORER® web browser by Microsoft Corporation or SAFARI® web browser by Apple Inc.) that corresponds to the logical location (e.g., an Internet Protocol address) of web server 104. In response, web server 104 may transmit a web page that is rendered on a display device of a client device (e.g., a mobile phone, desktop computer, etc.).

Additionally, web server 104 may enable a user to interact with one or more web applications provided in a transmitted web page or as part of an application executing on client device 106. A web application may provide user interface (UI) components that are rendered on a display device of client device 106. The user may interact (e.g., select, move, enter text into) with the UI components, and based on the interaction, the web application may update one or more portions of the web page. A web application may be executed in whole, or in part, locally on client device 106. The web application may populate the UI components with data from external sources or internal sources (e.g., data store 126) in various examples.

In various examples, the web application is a dynamic user interface that includes a non-textual visualization (e.g., graphical icon, chart, graph, animation, etc.) representing how an expenditure will affect a user's financial goals or budget. Further details about the dynamic user interface are discussed below in the context of other elements of application server 102.

The web application may be executed according to application logic 121. Application logic 121 may use the various elements of application server 102 to implement the web application. For example, application logic 121 may issue API calls to retrieve or store data from data store 126 and transmit it for display on client device 106. Similarly, data entered by a user into a UI component may be transmitted using API 122 back to the web server 104. Application logic 121 may use other elements (e.g., user interface compositor 114, impact determination component 118, etc.) of application server 102 to perform functionality associated with the web application as described further herein.

Data store 126 may store data that is used by application server 102. Data store 126 is depicted as singular element but may in actuality be multiple data stores. The specific storage layout and model used in by data store 126 may take a number of forms-indeed, a data store 126 may utilize multiple models. Data store 126 may be, but is not limited to, a relational database (e.g., SQL), non-relational database (NoSQL) a flat file database, object model, document details model, graph database, shared ledger (e.g., blockchain), or a file system hierarchy. Data store 126 may store data on one or more storage devices (e.g., a hard disk, random access memory (RAM), etc.). The storage devices may be in standalone arrays, part of one or more servers, and may be located in one or more geographic areas.

User accounts 128 may include user profiles on users of application server 102. A user profile may include credential information such as a username and hash of a password. The user profile may identify user preferences including budgetary goals, savings goals, or typical expenditures. Typical expenditures can be expressed according to categories, amounts to spend in each category, or other representations. Certain types of expenditures can include fixed expenditures, discretionary expenditures, “splurge” items, reward items, loan payments, fixed savings deposits, etc. More details about expenditures, budgets and goals are discussed in the context of the remaining components and figures.

User accounts 128 may also include a location of which electronic repository to obtain the expenditure and goal data. For example, an account may identify a third-party service that manages the user's debit cards, credit cards, or bank information. The account may include a token (e.g., using OAuth) or login credentials that authorize application server 102 to retrieve the events in a defined format such as JavaScript Object Notation (JSON) or extensible markup language (XML) over an API. In some examples, multiple sources of financial information may be used and combined in the user account. Each source may have a corresponding token or login credentials in order to retrieve the events.

A user account profile may also be linked (e.g., using credentials, APIs, tokens) to one or more financial accounts, such as checking accounts, savings accounts, credit cards, etc.

Impact determination component 118 may determine ways in which an expenditure can impact a user. For example, the impact determination component 118 can calculate how an expenditure in one discretionary area will impact the amount of money available to spend in a different discretionary area. The impact can be expressed as a number, for example a currency value, or the impact can be expressed in units of a product or service that a user might typically wish to spend discretionary funds on. Impact can be determined by subtracting a dollar amount from a discretionary spending budget, or by determining cost for products bought with the discretionary budget and then subtracting units of these products from a goal total, an ideal total, or a preferred total. This impact can be used to provide visualizations as described later herein.

To help with the calculation, impact determination component 118 may access a budget and current spending of the user. A budget may define spending amounts per category for the user and either application server 102 or a third-party service may track spending of the user with respect to those categories. In some examples, the user can provide an input (e.g., using a user interface component) detailing an amount of money spent, for example when the amount is spent using cash and therefore otherwise non-trackable through automated and computerized processes.

User interface compositor 114 may execute a number of subprocesses to generate a user interface for presentation on client device 106. For example, user interface compositor 114 may retrieve data that is to be presented as part of a user interface. The data may include expenditure data, budgetary goals and impacts as determined by the impact determination component 118, among others. In various examples, the interface is formatted using a canvas element in accordance with HTML5.

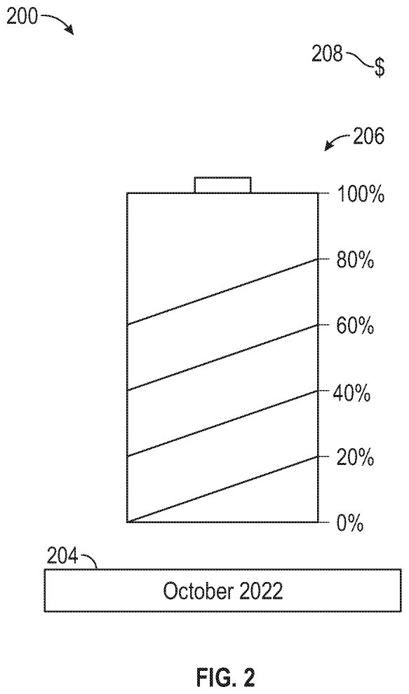

A visualization determination component 124 can determine the manner and format in which visualizations of expenditures, budgets, etc. will be displayed. In examples, the user can specify the visualizations presented on the client device 106, or the images and visualizations displayed can be automatically selected based on stock images or stored images. For example, if a budget relates to dinner, images of plate/s of food can be displayed, and the image can be selected by the user (e.g., based on a user's preferred dinners) or based on stock images retrieved online, or based on pre-selected stored images of dinner/s within a system (e.g., within the data store 126). As a further example, if the budget relates to coffee shop expenditures, images of coffee cups can be displayed. Examples of visualizations are provided below with reference to FIGS. 2-4.

FIG. 2 illustrates a first user interface 200 for providing an expenditure visualization, according to various examples. The user interface 200 can include a battery visualization, indicating varying levels of charge. For example, battery visualization 200 can indicate that all of a resource (e.g., money) is available for use (e.g., 100% of a budgeted amount remains to be used) in a specified time period 204. The visualization can adapt as a resource is used up by, e.g., changing coloration or shading indicating the fullness or level of charge of the visualization.

While a battery is depicted, any other container-type visualization can be used of varying levels of fullness. For example, rather than indicating amounts of money available to be used (e.g., the amount of money left to spend from a particular budget), the visualization can comprise, for example, a cup of coffee. In this example, a user may decide (or the system can decide for the user) that 10 cups of coffee can be purchased that week to remain in budget. A coffee cup visualization can be used, wherein the coffee cup eventually becomes “drained” as cups of coffee are purchased or consumed. Other similar visualizations can be selected by the user based on user interest. Furthermore, multiple visualizations can be provided to represent multiple budgets. For example, a first visualization can comprise a coffee cup of varying levels of fullness to represent a coffee budget; dinner plate visualizations can be provided to represent a dining budget, etc.

Numerical indicators can also be provided in conjunction with the visualization. For example, values 206 can indicate percent of budget remaining. A monetary indication 208 can be provided indicating dollars (or other currency) remaining in a budget. The monetary indication 208 can be expressed in numerals, or in a growing or shrinking dollar sign (or other currency) indicator, for example. For example, the monetary indication 208 may have a first size for a first amount of budget remaining, and a second, different size for a second amount of budget remaining. For example, the monetary indication 208 can shrink or grow in size on the user interface as expenditures increase or decrease throughout a given time period.

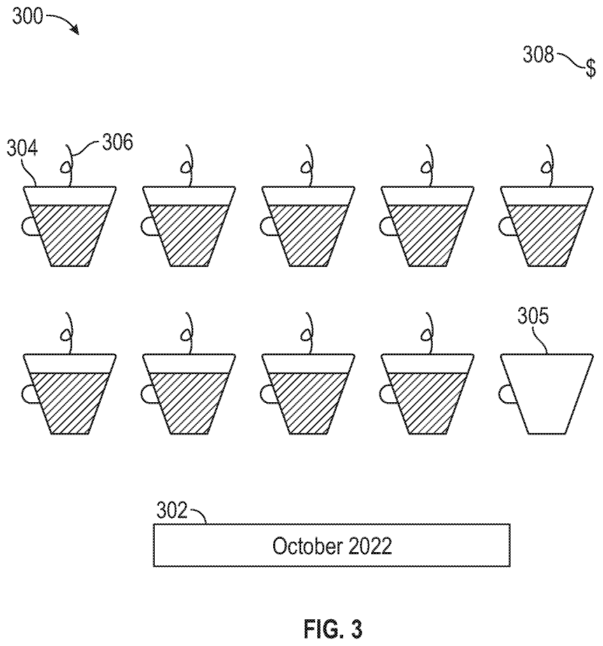

FIG. 3 illustrates a second example user interface 300 for providing an expenditure visualization, according to various examples. The user interface 300 can include a number of items (in the illustrated example, coffee cups) that can be consumed during a particular time period 302. As the coffee cups 304 are drained, a coffee cup 305 of the coffee cups 304 is depicted as empty. Animation 306 can be provided for added emotional and personal appeal, e.g., steam can be depicted rising from full coffee cups 304, whereas steam is missing from empty coffee cup 305. Such visualizations can help aid in entertainment and improve the motivational level of a user, helping the user to remain on budget.

While coffee cups are depicted, any other visualization can be used to, e.g., visualize different types of purchases. For example, if a user has determined to budget himself or herself five restaurant dinners per month, five food plates can be depicted, and food can disappear from the plates as meals are purchased/consumed. Furthermore, multiple visualizations can be provided to represent multiple budgets. For example, a first visualization can comprise coffee cups to represent a coffee budget; dinner plate visualizations can be provided to represent a dining budget, etc.

Numerical indicators can also be provided in conjunction with the visualization. For example, a monetary indication 308 can be provided indicating dollars (or other currency) remaining in a budget. The monetary indication 308 can be expressed in numerals, or in a growing or shrinking dollar sign (or other currency) indicator, for example. For example, the monetary indication 308 may have a first size for a first amount of budget remaining, and a second, different size for a second amount of budget remaining. For example, the monetary indication 208 can shrink or grow in size on the user interface as expenditures increase or decrease throughout a given time period 302.

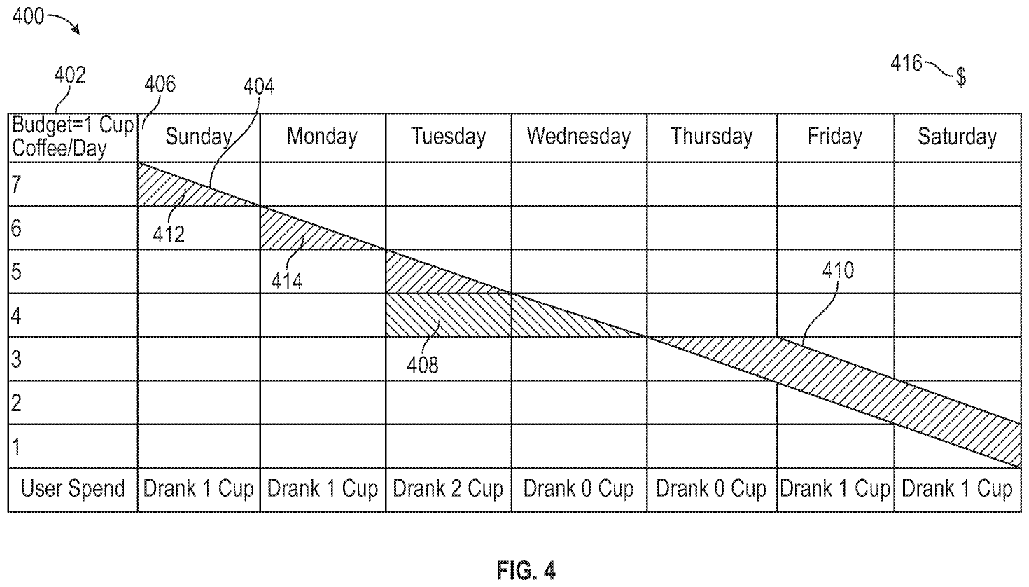

FIG. 4 illustrates a chart 400 for representing available expenditure over time, according to various examples. The chart 400 can be same or similar to a “burn down chart.” The chart 400 can be customizable by a user. For example, the user can specify a budget 402, in any desired units (e.g., dollars, cups of coffee, dinners) or a rate at which any of those items can be used. A time period can be specified, or a default time period can be used. In the illustrated example, a time period of one week can be used.

Based on the time period and based on the rate of burndown, or budget, a downward-sloping line 404 can be generated. For example, the line 404 can start at a maximum number to align with the time period (e.g., one cup of coffee per day for seven days starts at 7 cups) at point 406.

Each time one unit is consumed, purchased, etc., the number is reduced for that day. If the number consumed is greater than the budgeted rate of consumption, the chart 400 will provide a warning indication by, e.g., animations or changing colors, as shown at warning 408. If fewer than the budgeted amount for that day is consumed, indicators 410 can be provided, which can go above line 404 depending on where the consumption occurs in the time period.

With reference to FIG. 4, by way of example, a weekly coffee budget is specified as seven cups, or one cup of coffee per day. On Sunday, the user drank one cup of coffee, reflected in the decrease 412 for Sunday. The budgeted amount remaining for the week is therefore specified as 6. On Monday, the user drank one cup of coffee, reflected in the decrease 414 for Monday, and the decrease to five remaining cups. On Tuesday, the user drank two cups of coffee, resulting in a warning 408 and a reduction in the budget to three cups (rather than four cups which would have been the remaining budget but for the extra consumed cup on Tuesday). On Wednesday, the user did not drink coffee, and the budgeted remaining cups remained at three cups. Similarly, on Thursday the user did not drink coffee and accordingly now has extra coffee in his or her budget, reflected at 410, wherein the indicator 410 can in some cases go above line 404, if the user is under budget, e.g., if the user consumed less than the budgeted amount.

As with the previous examples, any units and any resource can be provided, and any time period can be specified. Numerical indicators can also be provided in conjunction with the visualization. For example, a monetary indication 416 can be provided indicating dollars (or other currency) remaining in a budget similarly to the previous examples.

The user can also add or remove visualizations or tracking at any time. For example, if a user decides to start tracking manicures, haircuts, pairs of shoes, trips to a golf course, etc., different visualizations and user interfaces can be initialized, generated, or displayed showing depictions of any of those services or activities. Tracking can be done across different visualizations. For example, if too much is spent on manicures, two cups of coffee may be removed from a coffee visualization. In some examples, if too much is spent in one area, the user can be provided a warning, e.g., “you golfed too much this month, so you cannot have coffee next week.” The system can also make suggestions for savings. For example, the system can suggest the user have three fewer cups of coffee in a given week to achieve a savings goal. The system can also be used to generate reports on spending. The system can be tethered to one particular credit card or debit card, or across multiple cards and bank accounts. The system can be tethered to a family or a household, to track family or household spending.

In any of the examples described herein, machine learning can be used to learn a user's consumption habits, typical amounts spent, favorite “splurge” items, etc. The user can also initialize the system with expected budget amounts and typical amounts spent, which can be adjusted through time as machine learning learns the user's habits. Visualizations can be suggested to the user, or the user can specify visualizations.

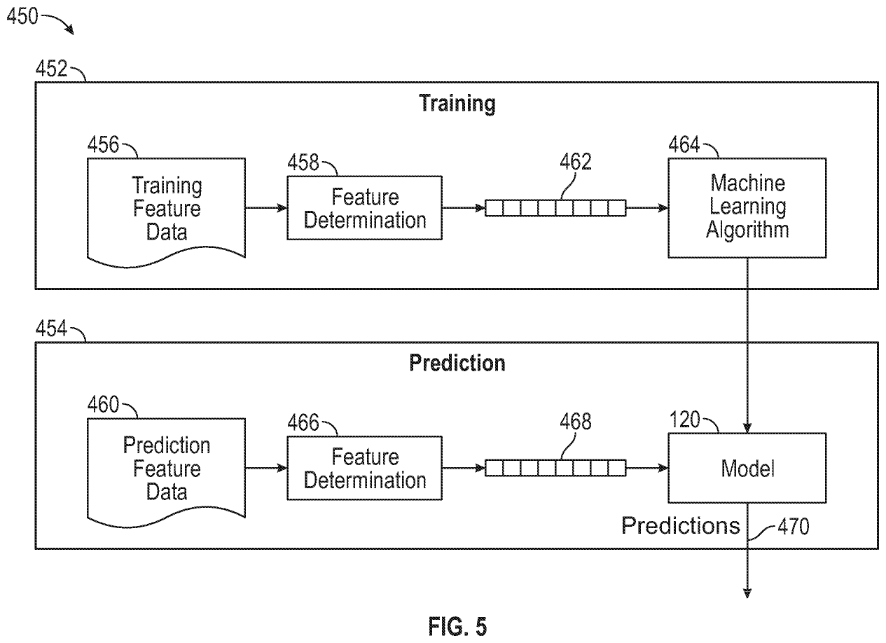

FIG. 5 illustrates an example machine learning module 450 for a decentralized asset dispositioning tool, according to various embodiments. The machine learning module 450 may be implemented in whole or in part by one or more computing devices. In some examples, the training module 452 may be implemented by a different device than the prediction module 454. In these examples, the model 120 may be created on a first machine and then sent to a second machine.

Machine learning module 450 utilizes a training module 452 and a prediction module 454. Training module 452 inputs training feature data 456 into feature determination module 458. The training feature data 456 may include data determined to be predictive of identifying a user's consumption habits. Categories of training feature data may include transaction history over a past time period (e.g., 12 months); expenditure details; individual financial history, typical amounts spent; favorite “splurge” items; and the like. In some examples, the financial history of the user may only utilize financial history of the account that is created by the user, but in other examples, other account history of other accounts (e.g., checking, savings, and the like) may also be used. For example, a history of deposits into a checking or savings account may be used.

Specific training feature data and prediction feature data 460 may include, for example one or more of: identified assets of the user, personal financial history of the user, data on fixed expenses, favorite merchants, and the like.

Feature determination module 458 selects training vector 462 from the training feature data 456. The selected data may fill training vector 462 and comprises a set of the training feature data that is determined to be predictive of the user's consumption habits, favorite merchants, or favorite “splurge” items. In some examples, the tasks performed by the feature determination module 458 may be performed by the machine learning algorithm 464 as part of the learning process. Feature determination module 458 may remove one or more features that are not predictive of non-allocated assets or candidate beneficiaries prior to training the model 120. This may produce a more accurate model that may converge faster. Information chosen for inclusion in the training vector 462 may be all the training feature data 456 or in some examples, may be a subset of all the training feature data 456.

In other examples, the feature determination module 458 may perform one or more data standardization, cleanup, or other tasks such as encoding non numerical features. For example, for categorical feature data, the feature determination module 458 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 462 may be utilized (along with any applicable labels) by the machine learning algorithm 464 to produce a model 120. In some examples, other data structures other than vectors may be used. The machine learning algorithm 464 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 454, prediction feature data 460 may be input to the feature determination module 466. The prediction feature data 460 may include the data described above for the training feature data. In some examples, the prediction module 454 may be run sequentially for one or more items. Feature determination module 466 may operate the same, or differently than feature determination module 458. In some examples, feature determination modules 458 and 466 are the same modules or different instances of the same module. Feature determination module 466 produces vector 468, which is input into the model 120 to produce predictions 470. In various examples the predictions 470 include identifying non-allocated assts of the user. In further examples the predictions 470 include identifying consumer spending habits and preferred “splurge” items, merchants, etc. Other types of predictions 470 may be used without departing from the scope of the present subject matter.

For example, the weightings and/or network structure learned by the training module 452 may be executed on the vector 468 by applying vector 468 to a first layer of the model 120 to produce inputs to a second layer of the model 120, and so on until the prediction 470 is output. As previously noted, other data structures may be used other than a vector (e.g., a matrix).

The training module 452 may operate in an offline manner to train the model 120. The prediction module 454, however, may be designed to operate in an online manner. It should be noted that the model 120 may be periodically updated via additional training and/or user feedback. For example, additional training feature data 456 may be collected. The feedback, along with the prediction feature data 460 corresponding to that feedback, may be used to refine the model by the training module 452.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 464 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

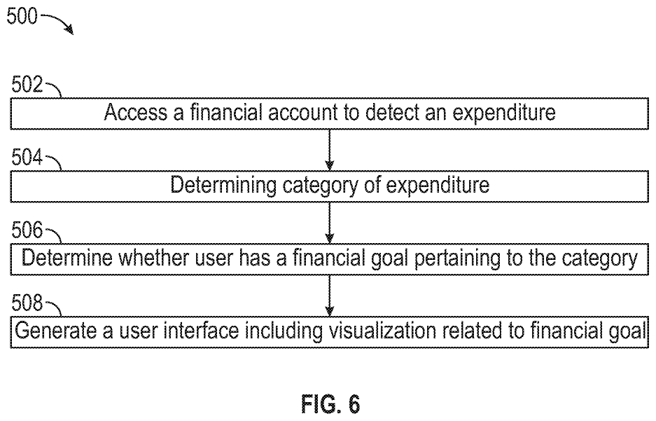

FIG. 6 is a flowchart illustrating a method for generating a user interface, according to various examples. The method is represented as a set of blocks that describe operation 502 to operation 508 of flowchart 500. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 6. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

In various examples, flowchart 500 includes operation 502 for accessing a financial account (e.g., user accounts 128) of a user to detect an expenditure. In various examples, flowchart 500 includes operation 504 for determining a category of the expenditure. This can be done using machine learning according to FIG. 5, or according to user input, location data, categorization by the financial institution from which funds are withdrawn, etc. In various examples, flowchart 500 includes operation 506 determining whether the user has a financial goal pertaining to the category. This determination can be based on user input of preferences.

In various examples, flowchart 500 includes operation 508 for generating a user interface, the user interface including a visualization pertaining to the financial goal. In examples, the visualization can include a graphic representing the category of the expenditure, wherein example graphics can include any graphics shown in FIG. 2-FIG. 5 or other graphics. As described earlier herein, the graphic can represent a percentage of a budget spent within the category of the expenditure. The visualization can include animation, or a textual indication proximate the visualization to indicate at least one of the category, the budget, or percentage of budget used. Several different visualizations can be provided to represent multiple financial goals, expenditure categories, etc., and a user can customize the user interface to remove or add goals, graphics, etc.

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

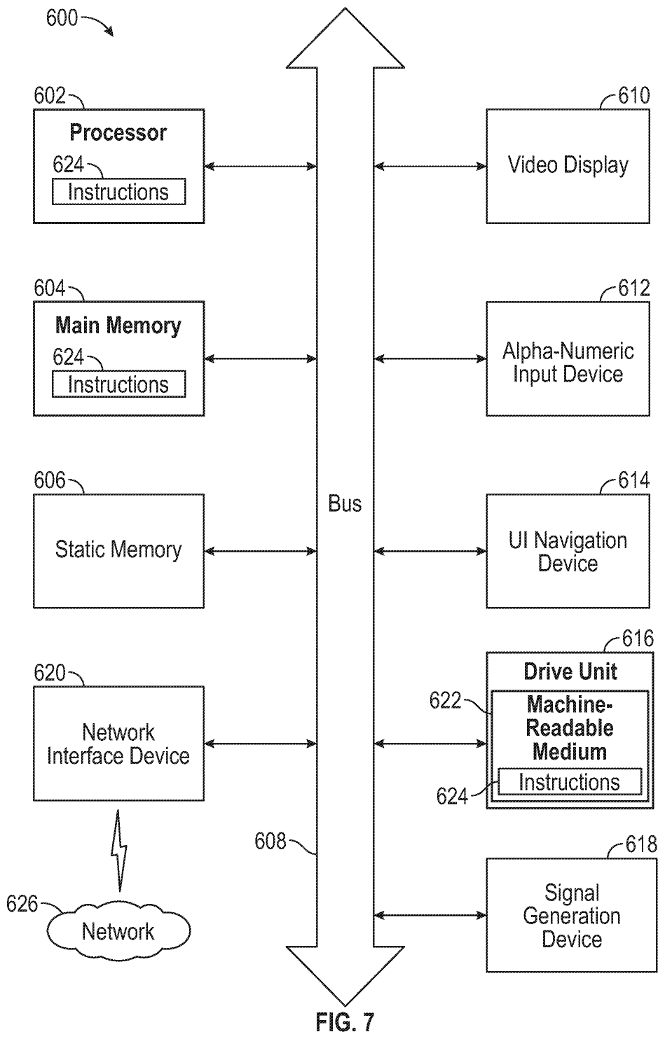

FIG. 7 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, 4G LTE/LTE-A or WiMAX networks, and 5G). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A computer-implemented method comprising:
accessing a financial account of a user to detect an expenditure;
determining a category of the expenditure;
determining whether the user has a financial goal pertaining to the category;
identifying, for the user, a likely impact of the expenditure on at least one of the financial goal pertaining to the category or a second financial goal pertaining to a second category;
selecting a non-textual visualization pertaining to the financial goal based on the likely impact, the non-textual visualization configured to change when the likely impact changes, the non-textual visualization having a shape that is visually representative of the financial goal;
generating a user interface, the user interface including the non-textual visualization pertaining to the financial goal; and
presenting the user interface including the non-textual visualization on a computing device of the user.

2. (canceled)

3. The computer-implemented method of claim 1, wherein the visualization includes a graphic representing the category of the expenditure.

4. The computer-implemented method of claim 3, wherein the graphic represents a percentage of a budget spent within the category of the expenditure.

5. The computer-implemented method of claim 3, wherein the visualization includes animation.

6. The computer-implemented method of claim 3, further comprising providing a textual indication proximate the visualization to indicate at least one of the category, a budget, or percentage of the budget used.

7. The computer-implemented method of claim 1, further comprising providing a plurality of visualizations to represent a plurality of financial goals.

8. The computer-implemented method of claim 1, wherein the visualization comprises a burndown chart.

9. The computer-implemented method of claim 1, wherein the visualization comprises at least one graphical icon.

10. The computer-implemented method of claim 1, further comprising:
receiving a user input of at least one of a typical amount spent in an expenditure category, and a preferred budget for the expenditure category.

11. The computer-implemented method of claim 1, further comprising:
executing a machine learning algorithm to determine at least one of a typical amount spent in an expenditure category and a preferred budget for the expenditure category.

12. A non-transitory computer-readable medium comprising instructions, which when executed by at least one processor, configure the at least one processor to perform operations comprising:
accessing a financial account of a user to detect an expenditure;
determining a category of the expenditure;
determining whether the user has a financial goal pertaining to the category;
identifying, for the user, a likely impact of the expenditure on at least one of the financial goal pertaining to the category or a second financial goal pertaining to a second category;
selecting a non-textual visualization pertaining to the financial goal based on the likely impact, the non-textual visualization configured to change when the likely impact changes, the non-textual visualization having a shape that is visually representative of the financial goal;
generating a user interface, the user interface including the non-textual visualization pertaining to the financial goal; and
presenting the user interface including the non-textual visualization on a computing device of the user.

13. The non-transitory computer-readable medium of claim 12,
wherein the visualization includes a graphic representing the category of the expenditure.

14. The non-transitory computer-readable medium of claim 13, wherein the graphic represents a percentage of a budget spent within the category of the expenditure.

15. The non-transitory computer-readable medium of claim 12, wherein operations further comprise: providing a plurality of visualizations to represent a plurality of financial goals.

16. The non-transitory computer-readable medium of claim 12, wherein the operations further comprise receiving a user input of at least one of a typical amount spent in an expenditure category, and a preferred budget for the expenditure category.

17. The non-transitory computer-readable medium of claim 12, wherein the operations further comprise:
executing a machine learning algorithm to determine at least one of a typical amount spent in an expenditure category and a preferred budget for the expenditure category.

18. A system comprising:
at least one processor; and
a storage device comprising instructions, which when executed by the at least one processor, configure the at least one processor to perform operations comprising:
accessing a financial account of a user to detect an expenditure;
determining a category of the expenditure;
determining whether the user has a financial goal pertaining to the category;
identifying, for the user, a likely impact of the expenditure on at least one of the financial goal pertaining to the category or a second financial goal pertaining to a second category;
selecting a non-textual visualization pertaining to the financial goal based on the likely impact, the non-textual visualization configured to change when the likely impact changes, the non-textual visualization having a shape that is visually representative of the financial goal;
generating a user interface, the user interface including the non-textual visualization pertaining to the financial goal; and
presenting the user interface including the non-textual visualization on a computing device of the user.

19. The system of claim 18,
wherein the visualization includes a graphic representing the category of the expenditure.

20. The system of claim 19, wherein the graphic represents a percentage of a budget spent within the category of the expenditure.
